(19) United States
(12) Patent Application Publication
(10) Pub. No.: US 2026/0320874 A1
(43) Pub. Date: Oct. 15, 2026

(54) PICTURE DISPLAY METHOD AND APPARATUS IN COMMUNICATION SCENARIO, COMPUTER DEVICE, AND STORAGE MEDIUM

(71) Applicant: TENCENT TECHNOLOGY (SHENZHEN) COMPANY LIMITED, Shenzhen (CN)

(72) Inventors: Tao WANG, Shenzhen (CN); Cuiying LI, Shenzhen (CN)

(21) Appl. No.: 19/696,200

(22) Filed: Jun. 2, 2026

Related U.S. Application Data
(63) Continuation of application No. PCT/CN2025/082848, filed on Mar. 17, 2025.

(30) Foreign Application Priority Data
Apr. 22, 2024 (CN) 202410491012.2

(51) Int. Cl. G06T 11/60; G06F 40/279; G10L 15/22; G10L 15/26; H04L 51/046

(52) U.S. Cl. CPC G06T 11/60; G06F 40/279; H04L 51/046; G10L 15/22; G10L 2015/223; G10L 15/26

(57) ABSTRACT

A picture display method includes: displaying, in a conversation page of an application, a first conversation message transmitted by a first object ; determining that the first conversation message comprises key information and prompt information that is with respect to a second object; displaying an interaction picture corresponding to the key information, the interaction picture including a virtual avatar of the first object and a virtual avatar of the second object ; and displaying a virtual prop in the interaction picture in response to that the first conversation message includes the virtual prop; or displaying, in response to that the first conversation message includes a virtual expression, that at least one virtual avatar in the interaction picture presents an expression corresponding to the virtual expression.

### CROSS-REFERENCES TO RELATED APPLICATIONS

This application is a continuation of PCT Application No. PCT/CN2025/082848, filed on Mar. 17, 2025, which claims priority to Chinese Patent Application No. 2024104910122, filed with the China National Intellectual Property Administration on Apr. 22, 2024 and entitled “INTERACTION METHOD AND APPARATUS IN COMMUNICATION SCENARIO, COMPUTER DEVICE, STORAGE MEDIUM, AND COMPUTER PROGRAM PRODUCT”, the entire contents of all of which are incorporated herein by reference.

### FIELD OF THE TECHNOLOGY

The present disclosure relates to the field of instant messaging technologies, and in particular, to an interaction picture display method and apparatus in a communication scenario, a computer device, and a storage medium product.

### BACKGROUND OF THE DISCLOSURE

In an instant messaging application scenario, a user usually communicates with another person via a private chat or a group chat. During some special time (for example, holidays), the user transmits some themed expression images to liven up interaction. However, such an interaction form is monotonous and cannot effectively improve an interaction effect.

### SUMMARY

According to various embodiments of the present disclosure, an interaction method and apparatus in a communication scenario, a computer device, a computer-readable storage medium, and a computer program product are provided.

The present disclosure provides a picture display method in a communication scenario, performed by a computer device. The method includes: displaying, in a conversation page of an application, a first conversation message transmitted by a first object; determining that the first conversation message comprises key information and prompt information that is with respect to a second object; displaying an interaction picture corresponding to the key information, the interaction picture including a virtual avatar of the first object and a virtual avatar of the second object; and displaying a virtual prop in the interaction picture in response to that the first conversation message includes the virtual prop; or displaying, in response to that the first conversation message includes a virtual expression, that at least one virtual avatar in the interaction picture presents an expression corresponding to the virtual expression.

The present disclosure further provides a computer device, the computer device including a memory and a processor, the memory having a computer program stored therein, and the processor, when executing the computer program, implementing operations of the interaction method in a communication scenario.

The present disclosure further provides a non-transitory computer-readable storage medium, the computer-readable storage medium having a computer program stored therein, the computer program, when executed by a processor, implementing operations of the interaction method in a communication scenario.

Details of one or more embodiments of the present disclosure are provided in the following drawings and descriptions. Other features and advantages of the present disclosure will become apparent from the specification, the accompanying drawings, and the claims.

### BRIEF DESCRIPTION OF THE DRAWINGS

FIG. 1 is a diagram of an application environment of an interaction method in a communication scenario according to an embodiment.

FIG. 2 is a schematic flowchart of an interaction method in a communication scenario according to an embodiment.

FIG. 3A is a schematic diagram of a page of an interaction picture according to an embodiment.

FIG. 3B is a schematic diagram of a page of an interaction picture according to another embodiment.

FIG. 3C is a schematic diagram of a page of an interaction picture according to another embodiment.

FIG. 4 is a schematic flowchart of an interaction method in a communication scenario according to another embodiment.

FIG. 5 is a schematic diagram of a page in which a virtual avatar of an other object is added to an interaction picture according to an embodiment.

FIG. 6 is a schematic diagram of a page in which a virtual avatar of an other object is added to an interaction picture according to another embodiment.

FIG. 7 is a schematic flowchart of displaying an interaction picture according to an embodiment.

FIG. 8 is a schematic diagram of a page in which group photo capture is performed on a virtual avatar in an interaction picture according to an embodiment.

FIG. 9 is a schematic diagram of a page in which a prompt is displayed after a group photo image or a group photo video is saved according to an embodiment.

FIG. 10 is a schematic flowchart of an interaction method in a communication scenario according to another embodiment.

FIG. 11 is a block of a structure of an interaction apparatus in a communication scenario according to an embodiment.

FIG. 12 is a block of a structure of an interaction apparatus in a communication scenario according to another embodiment.

FIG. 13 is a diagram of an internal structure of a computer device according to an embodiment.

### DESCRIPTION OF EMBODIMENTS

To make the objectives, technical solutions, and advantages of the present disclosure clearer, the following describes the present disclosure in further detail with reference to the accompanying drawings and the embodiments. Specific embodiments described herein are only used to explain the present disclosure, and are not used to limit the present disclosure.

In the following descriptions, related terms such as “first, second, and third” are merely intended to distinguish between similar objects but do not indicate a specific order of the objects. The “first, second, and third” are interchangeable in terms of a specific order or sequence if permitted, so that the embodiments of the present disclosure described herein can be implemented in an order in addition to the order shown or described herein.

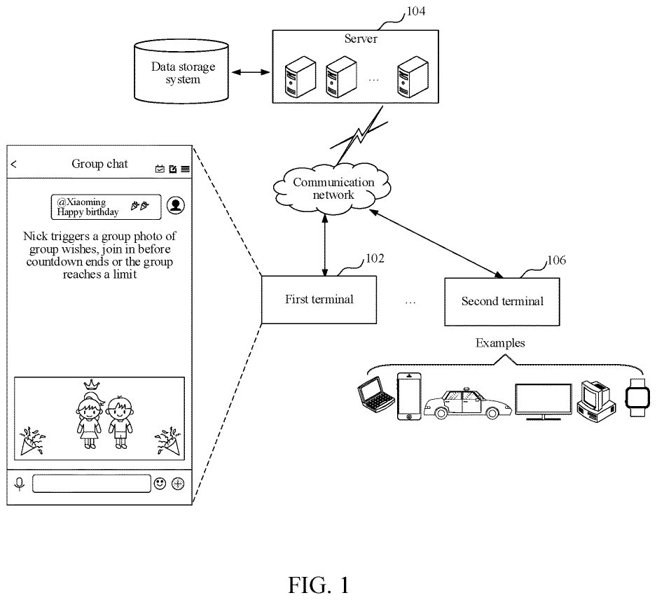

An interaction method in a communication scenario provided in this embodiment of the present disclosure may be applied to an application environment shown in FIG. 1. The interaction method used herein may refer to an interaction picture generation and display method. A terminal 102 communicates with a server 104 and a second terminal 106 via a network. A data storage system may store data to be processed by the server 104. The data storage system may be integrated on the server 104, or may be placed on a cloud or another network server.

The first terminal 102 displays, in a conversation page of an application, a first conversation message transmitted by a first object; displays an interaction picture corresponding to key information when the first conversation message includes the key information and prompt information that is with respect to a second object, the interaction picture including a virtual avatar of the first object and a virtual avatar of the second object; and displays a virtual prop in the interaction picture in response to that the first conversation message includes the virtual prop; or displays, in response to that the first conversation message includes a virtual expression, that at least one virtual avatar in the interaction picture presents an expression corresponding to the virtual expression. After displaying the interaction picture, the first terminal 102 may further transmit object information of the objects and identification information of a group photo template in the interaction picture to the server 104. The server 104 may transmit virtual avatars corresponding to the object information and the identification information to the second terminal 106, so that the second terminal 106 may display the interaction picture based on the identification information.

The first terminal 102 and the second terminal 106 may respectively be a smartphone, a tablet computer, a notebook computer, a desktop computer, an Internet of Things device, or a portable wearable device. The Internet of Things device may be a smart speaker, a smart television, a smart air conditioner, a smart in-vehicle device, or the like. The portable wearable device may be a smartwatch, a smart bracelet, a head-mounted device, or the like.

The server 104 may be an independent physical server, or may be a service node in a block chain system. Service nodes in the block chain system form a peer-to-peer network. A peer-to-peer protocol is an application-layer protocol running over a transmission control protocol (TCP). In addition, the server 104 may alternatively be a server cluster including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

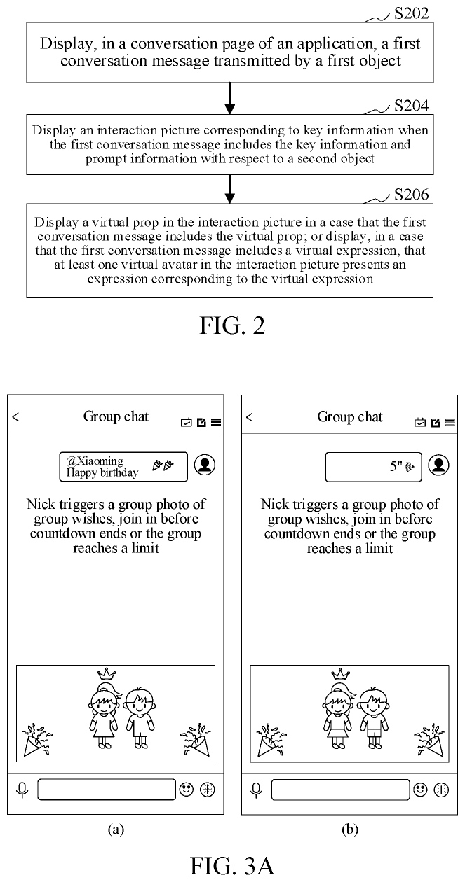

In an embodiment, as shown in FIG. 2, an interaction method in a communication scenario is provided. The method may be performed by a computer device, for example, performed by the server or the terminal in FIG. 1, or cooperatively performed by the server and the terminal. An example in which the method is performed by the terminal in FIG. 1 is used for description, and the method includes the following operations.

S202: Display, in a conversation page of an application, a first conversation message transmitted by a first object.

The application may be an instant messaging application, including a personal-level instant messaging application (a personal messaging application for short) and an enterprise-level instant messaging application (an enterprise messaging application for short). The personal messaging application may be a messaging application having a personal social attribute. The enterprise messaging application may be a messaging application having a work attribute and an instant messaging attribute. In other words, the enterprise messaging application may be used not only for instant messaging, but also for executing a work task, for example, checking in, managing leave and attendance, reserving an office, or initiating a conference. In addition, the application may alternatively be another application having an instant messaging function, for example, a video application, a shopping application, a takeout application, a sharing application, a livestreaming application, or a game application having an instant messaging function.

The conversation page may be an interaction page in which the first object and a second object perform one-to-one interaction (for example, chatting), or may be an interaction page of a communication group to which the first object and the second object belong. The communication group may be an interactive group or a discussion group including objects using the application, or may be an interactive group including objects using the application and objects using another application, for example, a client group including objects using a personal messaging application and objects using an enterprise messaging application, that is, members in the client group include the objects using the personal messaging application and the objects using the enterprise messaging application.

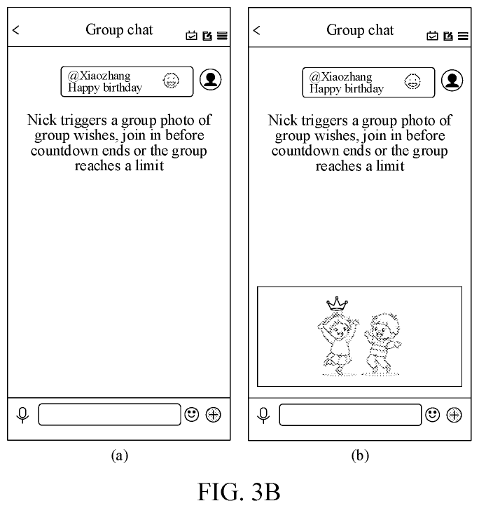

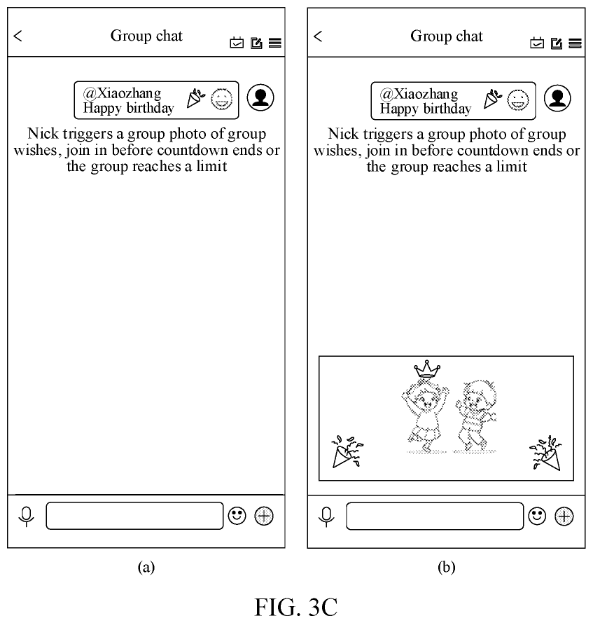

The first object may be a user that transmits the first conversation message, for example, the user that first transmits “@Xiaoming Happy birthday”, as shown in (a) in FIG. 3A. In addition, the first object may alternatively be a system assistant that transmits the first conversation message, for example, an intelligent assistant for human-computer interaction in a social application.

The first conversation message may be a dialog message for communication between different objects, and the first conversation message may be a conversation message of a text type, an image-text type, an audio type, or a video type. The first conversation message may be a conversation message in a local language or another regional language. In the application solutions, information detection may be performed on conversation messages with various speech, for example, precise matching and fuzzy matching of keywords in different languages, and detection of prompt information in different languages, to detect whether the first conversation message includes key information and prompt information that is with respect to the second object. In addition, the first conversation message may be a group conversation message transmitted by the first object via the communication group, for example, a group conversation message transmitted by the user or the system assistant in the communication group. In addition, the first conversation message may alternatively be a conversation message transmitted via a private chat (for example, transmitted to the second object via a one-to-one private chat), for example, a conversation message transmitted by the user or the system assistant via a one-to-one private chat.

The first conversation message of the image-text type may be a message, or may be a message including two messages, for example, a conversation message of a text type and a conversation message of a picture type. The conversation message of the text type may include the prompt information (for example, “@Xiaoming”) with respect to the second object, and the conversation message of the picture type may include the key information or information corresponding to the key information (for example, an expression picture displaying “Happy birthday”, or an expression picture displaying “a cake”).

In an embodiment, the terminal may first receive the first conversation message transmitted by the first object. When the first conversation message is a conversation message of the text type or the image-text type, the first conversation message is displayed in the conversation page of the application. When the first conversation message is a conversation message of the audio type or the video type, a media identifier representing the first conversation message is displayed in the conversation page.

The terminal may be a device held by the first object, or may be a device held by the second object, or may be a device held by an other object (for example, another member in the communication group). In subsequent embodiments, if not specifically stated, an example in which the terminal is the device held by the first object is used for description.

The media identifier may be a conversation identifier representing the conversation message of the audio type or the video type.

The first conversation message of a different type may have a different display manner. For example, when the first conversation message is the message of the text type or the image-text type, the first conversation message may be directly displayed, as shown in (a) in FIG. 3A. When the first conversation message is the message of the audio type or the video type, a corresponding media identifier is displayed in the conversation page, for example, when the first conversation message is the conversation message of the audio type, the media identifier may be a conversation identifier representing the audio type, as shown in (b) in FIG. 3A.

S204: Display an interaction picture corresponding to key information when the first conversation message includes the key information and prompt information that is with respect to a second object.

The key information may be a preset keyword that may trigger interaction, for example, “happy birthday” in “@Xiaoming Happy birthday” transmitted on a birthday, or “to the penguin major family” in “Welcome @Xiaozhang to the penguin family” transmitted during welcome. In addition, the key information may alternatively be other text information or picture information corresponding to the preset keyword.

The prompt information may be a name of the second object, or combined information of the name of the second object and a symbol for object prompt. In some actual application scenarios, the symbol may be a symbol “@”.

The interaction picture may be a picture that is configured for interaction between different objects or virtual avatars of the different objects and that is corresponding to the key information. The interaction picture may alternatively be referred to as a group avatar collage picture. If applied to a communication group, the interaction picture may be referred to as a group avatar collage picture of the group, and includes a virtual avatar of the first object and a virtual avatar of the second object. The virtual avatar may be a virtual character or a virtual animal in a cartoon form. Each object selects, in a model library of the application program, a corresponding virtual avatar based on interests and hobbies. When needed for use in some application scenarios, the virtual avatar is obtained for display. When the first object is the system assistant, the virtual avatar of the first object may be a virtual avatar of the system assistant, and the virtual avatar may be a preset cartoon image of the system assistant. The virtual avatar of the system assistant may correspond to an enterprise log of a developer of the application (for example, a social application).

The interaction picture is corresponding to the key information may mean that a first virtual object in the interaction picture presents a posture corresponding to the key information, or expresses a word corresponding to the key information. The word may be displayed in a form of a special effect word.

For example, assuming that the first conversation message transmitted by Xiaoli (that is, the user that transmits the first conversation message) to Xiaoming is “@Xiaoming Happy birthday”, the interaction picture may be a group avatar collage picture of a virtual avatar of Xiaoming and a virtual avatar of Xiaoli. In addition, the virtual avatar of Xiaoli in the interaction picture makes a posture to wish Xiaoming a happy birthday, or says a speech of happy birthday to Xiaoming. For another example, assuming that on Xiaoming's birthday, the intelligent assistant transmits the first conversation message of which content is “@Xiaoming Happy birthday” to Xiaoming, the interaction picture may be a group avatar collage picture of the virtual avatar of Xiaoming and a virtual avatar of the intelligent assistant.

In addition, the interaction picture may further include a group photo template corresponding to the key information. For example, the first conversation message is “@Xiaoming Happy birthday”, and the group photo template may include at least one of a background image, a lighting effect, a dynamic special effect, a static special effect, or the like having a birthday atmosphere or a birthday element. The group photo template may be determined by the terminal based on the key information, or may be determined by the terminal in response to a selection operation of the first object. The selection operation of the first object may be selecting based on the key information.

In an embodiment, when the first conversation message is the conversation message of the audio type or the video type, the terminal may perform speech recognition on the first conversation message, to obtain a speech recognition text; and detect whether the speech recognition text includes the key information and the prompt information that is with respect to the second object. When the first conversation message is the conversation message of the audio type or the video type, the terminal may directly detect whether the first conversation message includes the key information and the prompt information that is with respect to the second object.

In an embodiment, when the first conversation message includes the key information and the prompt information that is with respect to the second object, the terminal may automatically enable a function for displaying a virtual avatar to perform group photo interaction, and then display the virtual avatar of the first object and the virtual avatar of the second object. The image of the first object may present a posture corresponding to the key information, or express a word corresponding to the key information. Alternatively, when the first conversation message includes the key information and the prompt information that is with respect to the second object, the terminal may automatically enable a function for displaying a virtual avatar to perform group photo interaction, and then display the group photo template corresponding to the key information, the virtual avatar of the first object, and the virtual avatar of the second object. In a display process, the virtual avatar of the first object and the virtual avatar of the second object may be dynamically changed. For example, a posture changes based on the key information. In a specific application scenario, the virtual avatar may perform a birthday dance, sing a birthday song, or the like.

In an embodiment, when a virtual object is displayed, an account name of each object may be displayed at a corresponding position (for example, above a head, below feet, or at another unblocked position) of the virtual object. The account name may be a name registered by each object, for example, a nickname used by the user on the instant messaging application. If the instant messaging application is an enterprise messaging application, the account name may alternatively be a name of the user, to promote understanding of enterprise staff.

Before the interaction picture is displayed, the terminal may first display a group avatar collage interface, and render a group avatar collage module (for example, a group avatar collage region) in the group avatar collage interface, so that the interaction picture is displayed in the group photo module of the group.

S206: Display a virtual prop in the interaction picture in response to that the first conversation message includes the virtual prop; or display, in response to that the first conversation message includes a virtual expression, that at least one virtual avatar in the interaction picture presents an expression corresponding to the virtual expression.

The virtual prop may refer to an emoji of a prop type. The first object may express a current psychological state or emotional state through the virtual prop, or convey wishes to another person. For example, the virtual prop is a virtual cake or virtual fireworks, and is used to express birthday wishes to the second object. In some specific application scenarios, the virtual prop may include a virtual prop related to an atmosphere, for example, the virtual fireworks, and this type of virtual prop may be displayed at a corresponding position (for example, a corner position) of the interaction picture. Alternatively, the virtual prop may include a virtual prop of an item type that is worn on or placed near an object, and this type of virtual prop may be displayed on a body part of a virtual avatar, or near the virtual avatar. The virtual prop may be displayed based on the foregoing position, or may be customized by the first object, the second object, or an other object.

The virtual prop displayed in the interaction picture may be the virtual prop in the first conversation message, or may be a virtual prop that is generated based on the virtual prop in the first conversation message and that has a corresponding special effect, for example, has a dynamic effect. In addition, image resolution may be higher.

The virtual expression may be an emoji of a human facial expression type. The first object may express the current psychological state or emotional state through the virtual prop. For example, the virtual expression is a smiling face expression, so that a pleasant mood of the first object may be presented, and the virtual avatar of the first object presents a smiling expression in the interaction picture. The virtual avatar of the second object may also present the expression corresponding to the virtual expression.

In an embodiment, the first conversation message is a conversation message of the text type or the image type; and the method further includes: obtaining, by the terminal in response to that the first conversation message includes target interaction information, a target virtual prop corresponding to the target interaction information from an expression library, and displaying the obtained target virtual prop in the interaction picture; or generating a corresponding target virtual prop based on the target interaction information, and displaying the generated target virtual prop in the interaction picture. In addition, if a large quantity of virtual props corresponding to the target interaction information are obtained from the expression library, label elements may be displayed for the first object to select, or a specified quantity of virtual props may be displayed.

The target interaction information may be a specific word having a correspondence with the target virtual prop, for example, a cake, kisses, or love you. When the first conversation message is the conversation message of the text type or the image-text type, the target interaction information may be input by the first object. When the first conversation message is the conversation message of the audio type or the video type, the target interaction information may be transmitted by the first object in a speech form.

For example, if the first conversation message includes the target interaction information, the target virtual prop corresponding to the target interaction information may be obtained from the expression library (for example, a local expression library or an online expression library of the first object), and then the target virtual prop is displayed at a corresponding position in the interaction picture. For example, the virtual cake is displayed in a hand of the first object in the interaction picture. For another example, a graphical love is displayed in the interaction picture in front of the virtual avatar of the first object (with the virtual avatar of the second object opposite). The virtual avatar of the first object may make a pouty face, and the virtual avatar of the second object may make a happy or shy expression. In addition, in addition to obtaining the target virtual prop corresponding to the target interaction information from the expression library, the terminal may alternatively input the target interaction information into a generative model. The generative model generates, based on the target interaction information, a target virtual prop having a corresponding special effect, and then displays the target virtual prop in the interaction picture.

The generative model may be a generative adversarial network model, a variational autoencoder, a diffusion model, or another model based on Transformer.

In another embodiment, the first conversation message is the conversation message of the text type or the image type; and the method further includes: determining, by the terminal in the case that the first conversation message includes the target interaction information, the target virtual expression corresponding to the target interaction information, and generating, based on the target interaction information and the virtual avatar, a virtual avatar having an expression corresponding to the virtual expression, so that the virtual avatar in the interaction picture presents the expression corresponding to the virtual expression.

The virtual avatar having an expression corresponding to the virtual expression may be generated through the generative model.

In an embodiment, the terminal may detect whether the first conversation message includes an emoji or the target interaction information. In response to that the first conversation message includes the emoji, if the emoji is the emoji of the prop type (namely, the virtual prop), the virtual prop is displayed in the interaction picture; or if the emoji is the emoji of the human facial expression type (that is, the virtual expression), the at least one virtual avatar in the interaction picture is controlled to display the expression corresponding to the virtual expression. For example, the virtual expression is the smiling face expression, and the virtual avatar presents the smiling expression.

For example, when the first conversation message is the conversation message of the text type or the image-text type, the terminal may detect whether the first conversation message includes the emoji. If the virtual fireworks are included, the virtual fireworks are displayed at a corresponding position (for example, the corner position in the interaction picture) in the interaction picture. For another example, if the virtual cake is included, the virtual cake is displayed in hands of the first object (with two hands of the first object in a cake-holding posture) in the interaction picture.

In an embodiment, in the case that the first conversation message includes the emoji, if the emoji is the virtual prop, the terminal may alternatively generate the target virtual prop having the corresponding special effect through the generative model with reference to the virtual prop and preset description information, and then display the target virtual prop in the interaction picture. Alternatively, if the emoji is the virtual expression, the terminal may generate the virtual avatar having the expression corresponding to the virtual expression through the generative model with reference to the virtual expression and the virtual avatar, so that the virtual avatar in the interaction picture presents the expression corresponding to the virtual expression.

For example, if the emoji is a virtual expression of laughing happily, the terminal may alternatively generate a virtual avatar that laughs happily through the generative model with reference to the virtual expression of laughing happily and the virtual avatar, so that the virtual avatar in the interaction picture presents an expression of laughing happily, as shown in FIG. 3B.

In another embodiment, in the case that the first conversation message includes the emoji, if the emoji includes the virtual prop and the virtual expression, the terminal may control the virtual avatar to present the expression corresponding to the virtual expression. For example, the virtual expression is the smiling face expression, the virtual avatar presents the smiling expression. In addition, the virtual prop may be directly displayed in the interaction picture, or the target virtual prop having the corresponding special effect may be displayed in the interaction picture. The target virtual prop may be generated based on the virtual prop.

For example, if the emoji includes the virtual fireworks and the virtual expression of laughing happily, the terminal may control the virtual avatar to present the expression of laughing happily. In addition, the virtual fireworks may be directly displayed in the interaction picture, or virtual fireworks having a dynamic special effect may be displayed in the interaction picture, as shown in FIG. 3C.

In an embodiment, when the first conversation message is the conversation message of the audio type or the video type, the terminal first performs speech recognition on the first conversation message, to obtain a speech recognition text; and displays the target virtual prop corresponding to the target interaction information in the interaction picture in response to that the speech recognition text includes the target interaction information.

For example, when the first conversation message is the conversation message of the audio type or the video type, the terminal may perform speech recognition on the conversation message of the audio type or perform speech recognition on speech in the conversation message of the video type, to obtain the speech recognition text. If the speech recognition text includes the target interaction information, the target virtual prop corresponding to the target interaction information is obtained from the expression library, and then the target virtual prop is displayed at a corresponding position in the interaction picture. For example, the target interaction information is kisses, and a graphical love is displayed in the interaction picture in front of the virtual avatar of the first object (with the virtual avatar of the second object opposite). The virtual avatar of the first object may make the pouty face, and the virtual avatar of the second object may make the happy or shy expression.

In addition, for displaying the interaction picture on a terminal of an other object, the terminal of the first object may transmit target information including identification information of a group photo template, object information of the first object, and object information of the second object to a server, so that the server transmits the identification information and virtual avatars corresponding to the object information to the terminal of the other object, thereby displaying the interaction picture on the terminal of the other object. In addition, the server may alternatively actively push the identification information and the virtual avatars corresponding to the object information to the terminal of the other object.

In an embodiment, the terminal may further display, on the virtual avatar of the second object, a virtual prop indicating that the second object is a protagonist (e.g., main character).

The virtual prop indicating that the second object is the protagonist may be a virtual item having a feature of a protagonist, for example, a virtual crown or a birthday hat, or may be another animation image or emotion image. The virtual prop indicating that the second object is the protagonist may change as a posture and an angle of the second virtual object change, to match the second object.

In an embodiment, the terminal may obtain a virtual prop having the feature of a protagonist from the server based on the key information, or generate a virtual prop having the feature of a protagonist based on the key information. For example, the terminal invokes a large model (for example, a text-generated video model) to generate the virtual prop having the feature of a protagonist, and then displays the virtual prop having the feature of a protagonist on the second object in the interaction picture.

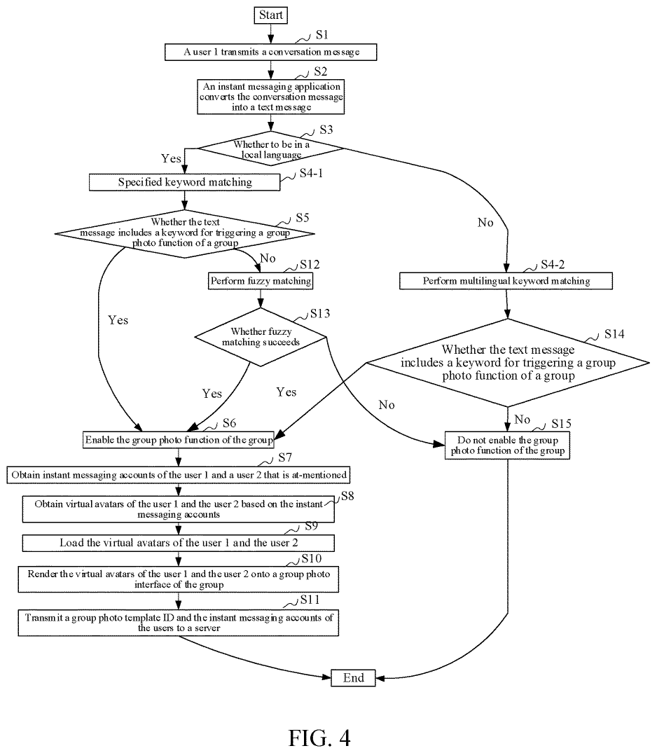

To better understand a group photo interaction manner in the present disclosure, descriptions are provided herein with reference to FIG. 4. Details are as follows.

S1: A user 1 transmits a conversation message.

S2: An instant messaging application converts the conversation message into a text message if the conversation message is of a speech type.

S3: Determine whether the text message is in a local language.

S4-1: If the text message is in the local language, perform specified keyword matching to obtain a matching result a.

S5: Determine, based on the matching result a, whether the text message includes a keyword for triggering a group photo function, and if the keyword is included, perform S6. Otherwise, perform S12.

S6: Enable the group avatar collage function.

S7: Obtain instant messaging accounts of the user 1 and a user 2 that is at-mentioned.

S8: Obtain virtual characters of the user 1 and the user 2 based on the messaging accounts.

S9: Load the virtual characters of the user 1 and the user 2.

S10: Render the virtual characters of the user 1 and the user 2 onto a group avatar collage interface.

S11: Transmit a group photo template ID and the instant messaging accounts of the users to a server.

S12: Perform fuzzy matching to obtain a matching result b.

S13: Determine, based on the matching result b, whether the text message includes a word corresponding to the keyword for triggering the group photo function, and if the word is included, perform S6 to S11. Otherwise, perform S15.

S4-2: If the text message is not in the local language, perform multilingual keyword matching to obtain a matching result c.

S14: Determine, based on the matching result c, whether the text message includes a keyword for triggering a group photo function, and if the keyword is included, perform S6 to S11. Otherwise, perform S15.

S15: Do not enable the group avatar collage function.

In addition, after rendering the virtual characters of the user 1 and the user 2 onto the group avatar collage interface, a conversation message transmitted by another user may continue to be received, and a virtual character of the another user is rendered onto the group photo interface when the conversation message meets a corresponding condition.

In the foregoing embodiments, the first conversation message transmitted by the first object is displayed in the conversation page of the application, and when the first conversation message includes the key information and the prompt information that is with respect to the second object, the interaction picture that is corresponding to the key information and that includes the virtual avatar of the first object and the virtual avatar of the second object is displayed. Therefore, not only is interaction performed in a message level, but also the virtual avatars of the objects participating in the conversation are associated, so that interaction between the virtual avatars of the objects is presented, which facilitates improvement of an interaction effect. In addition, in the case that the first conversation message includes the virtual prop, the virtual prop is displayed in the interaction picture. Alternatively, in the case that the first conversation message includes the virtual expression, that the at least one virtual avatar in the interaction picture presents the expression corresponding to the virtual expression is displayed, so that the virtual avatar presents the expression corresponding to the virtual expression, thereby increasing an interaction atmosphere, facilitating more objects to participate in interaction, and effectively improving an interaction rate.

In an embodiment, when the first conversation message is the conversation message transmitted by the first object in the communication group, that is, the first object and the second object are members in the communication group, after S204, the terminal may display, in the conversation page, a second conversation message transmitted by the other object in the communication group; and display a virtual avatar of the other object in the interaction picture when the second conversation message includes the key information or the information corresponding to the key information.

The other object may be one or more group members in the communication group other than the first object and the second object. The term “a plurality of” may be two or more. The information corresponding to the key information may be information that is not preset but express a meaning the same as or similar to that of the key information. For example, the key information is “Happy birthday”, and the information corresponding to the key information may be “Happy birthday”, “HBD”, or “+1”. “+1” may indicate that the user also transmits content the same as that of a foregoing conversation message, but uses “+1” as a replacement for brevity.

After receiving the second conversation message, the terminal may further detect whether the second conversation message includes a virtual prop or a virtual expression. If the virtual prop or the virtual expression is included, the virtual avatar of the other object is displayed in the interaction picture, and the virtual prop is also displayed, or the virtual avatar of the other object is controlled to present an expression corresponding to the virtual expression.

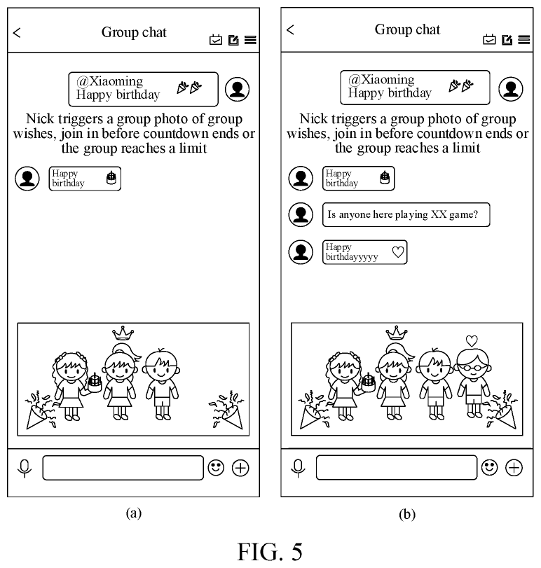

For example, after the first object transmits a conversation message of happy birthday to Xiaoming in the communication group, if the other object in the communication group follows the conversation message of happy birthday, the virtual avatar of the other object is added to the interaction picture for display. In addition, if the conversation message further includes a virtual prop, the virtual prop is displayed at a corresponding position in the interaction picture. For example, the virtual prop is a virtual cake, and the virtual cake is displayed in a hand of the virtual avatar of the other object, so that a picture in which the virtual avatar of the other object holds the cake in hand is presented, as shown in (a) and (b) in FIG. 5.

In an embodiment, before displaying the virtual avatar of the other object, the terminal may further perform time determination, to determine whether to display the virtual avatar in the interaction picture. Specifically, when receiving the second conversation message transmitted by the other object in the communication group, the terminal obtains receiving time of the second conversation message; and displays the virtual avatar of the other object in the interaction picture when the second conversation message includes the key information or the information corresponding to the key information and the receiving time meets a preset time condition.

The preset time condition may be a preset time interval in which a virtual avatar may be displayed, for example, 0 to 2 minutes after the interaction picture starts to be displayed. In addition, the preset time condition may alternatively be a preset time value for which a virtual avatar may be displayed, countdown is performed after the interaction picture starts to be displayed, and an initial value is the time value.

In addition, when the second conversation message includes the key information or the information corresponding to the key information, and the receiving time meets the preset time condition, the terminal may further determine whether a quantity of virtual objects in the interaction picture meets a preset quantity condition, for example, whether the quantity of the virtual objects is greater than or equal to a quantity threshold. If yes, the virtual avatar of the other object is displayed in the interaction picture. In addition, in response to that the second conversation message transmitted by the other object includes the first virtual prop, the virtual expression, and/or target interaction information, display is performed in the manner according to the foregoing embodiments.

In an embodiment, to make each of the objects more intuitively understand a time condition and a quantity condition of a group photo, the terminal may display countdown, a specified quantity upper limit, and a quantity of currently displayed virtual avatars in the interaction picture.

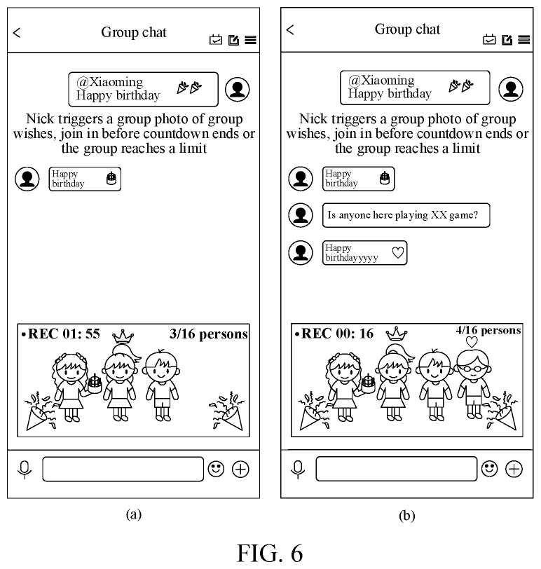

For example, when the other object in the communication group also transmits a conversation message, receiving time of the conversation message is recorded. If the receiving time falls within the preset time interval and the conversation message includes happy birthday, the virtual avatar of the other object and a corresponding virtual prop are displayed in the interaction picture. In addition, the terminal may further display countdown, the specified quantity upper limit, and the quantity of currently displayed virtual avatars in the interaction picture, as shown in (a) and (b) in FIG. 6.

In an embodiment, there are at least two other objects. To highlight the feature of a protagonist of the second object, in the display process, the terminal displays the virtual avatars of the other objects on two sides or around the second object by using a position of the second object as a center.

For example, the virtual avatars of the other object are displayed on the two sides of the second object by using the position of the second object as the center. Alternatively, the virtual avatars of the other object are displayed around the second object by using the position of the second object as the center.

The group photo function may be enabled in the following three manners.

Manner 1: Enable the function by means of semantic detection before the conversation message is transmitted.

In an embodiment, the interaction method is applied to the terminal held by the first object. In a process in which the first object inputs the conversation message, inputted conversation content is detected, to obtain a first detection result. When the first detection result includes the key information and the prompt information that is with respect to the second object, the function for displaying the virtual avatar to perform group photo interaction is enabled.

The function of group photo interaction (the group photo function for short) may be a function provided for the user to perform interaction and a group photo. When the group photo function is enabled, an interaction picture including virtual information may be displayed, and when a corresponding condition is met, image or video capture is performed on the interaction picture to obtain a group photo image or a group photo video.

When inputting the conversation content, the terminal may detect the inputted conversation content at a short interval, for example, at an interval of 5 seconds or 10 seconds.

For example, in a process in which the user inputs a text in an input box, detection may be performed at the interval of 5 seconds. The interval does not need to be excessively short during detection, to prevent invalid detection from being performed before the user inputs a next character.

In another embodiment, when the first detection result includes the key information and the prompt information that is with respect to the second object, a group photo confirmation page is displayed, which supports a group photo startup confirmation prompt to pop up in an input process, so that a user-friendly interaction process is improved. In response to a confirmation operation triggered in the group photo confirmation page, the function for displaying a virtual avatar to perform group photo interaction is enabled, so that corresponding interaction is performed under authorization of the user, thereby facilitating improvement of user experience. “In response to” is representing a condition or a status on which an executed operation depends, and when a dependent condition or status is met, one or more executed operations may be in real time or may have a set delay. Unless otherwise specified, there is no limitation on a sequence in which a plurality of operations are executed.

Manner 2: Enable the function by means of semantic detection after the conversation message is transmitted.

In an embodiment, after receiving the first conversation message transmitted by the first object, the terminal detects whether the first conversation message includes the key information and the prompt information that is with respect to the second object. If yes, the function for displaying a virtual avatar to perform group photo interaction is enabled, and then the interaction picture corresponding to the key information is displayed.

In addition, if the first conversation message includes the key information and the prompt information that is with respect to the second object, the terminal may further first display the group photo confirmation page, and enables, in response to the confirmation operation triggered in the group photo confirmation page, the function for displaying a virtual avatar to perform group photo interaction.

Manner 3: Enable the function by means of specific speech control or in a manual manner.

In an embodiment, the interaction method is applied to the terminal held by the first object. The terminal receives control speech transmitted by the first object, and activates, when the control speech includes a group photo enabling command, the function for displaying a virtual avatar to perform group photo interaction (also referred to as the function for group photo interaction based on virtual avatar); or activates, in response to a triggered group photo enabling operation, the function for displaying a virtual avatar to perform group photo interaction.

The control speech may be a sound emitted by the first object, and the group photo enabling command may be a command for enabling the group photo function.

The terminal performs speech recognition on the control speech, to obtain a speech recognition text, and then detects whether the speech recognition text includes the group photo enabling command. The group photo enabling command may be “Activate a group photo function”, so that the group photo function is enabled based on the group photo enabling command.

In the foregoing embodiments, detection is performed on the inputted conversation content, and the group photo function is enabled when the detection result meets a condition, so that the group photo function is enabled in advance, and the group photo startup confirmation prompt is supported to pop up in the input process, thereby improving the user-friendly interaction process. In addition, the group photo function may alternatively be enabled by means of speech control and manual operation, and after the conversation message is transmitted, the group photo function is imperceptibly triggered based on content in the conversation message, to prevent the user from being bothered in an interaction process. In addition, the group photo function may be enabled in a more noticeable manner.

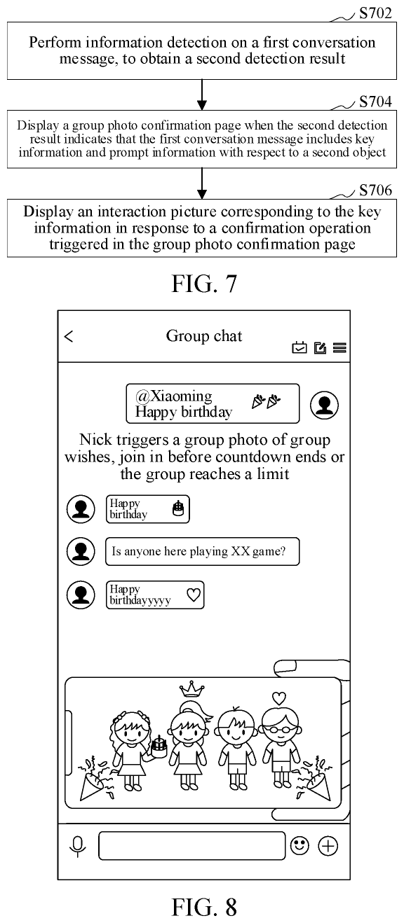

In an embodiment, the method is applied to the terminal held by the first object, and after the terminal receives the first conversation message, as shown in FIG. 7, the method further includes the following operations.

S702: Perform information detection on a first conversation message, to obtain a second detection result.

S704: Display a group photo confirmation page when the second detection result indicates that the first conversation message includes key information and prompt information that is with respect to a second object.

The group photo confirmation page may be a page provided for a user to confirm whether a group photo needs to be performed. The group photo confirmation page may include a confirmation control and a cancellation control.

S706: Display an interaction picture corresponding to the key information in response to a confirmation operation triggered in the group photo confirmation page.

In an embodiment, in response to an operation triggered on the confirmation control in the group photo confirmation page, the terminal enables a function for displaying a virtual avatar to perform group photo interaction, and then displays the interaction picture corresponding to the key information. In response to an operation triggered on the cancellation control in the group photo confirmation page, the terminal does not display the interaction picture corresponding to the key information.

In an embodiment, the interaction picture further includes a group photo template. Therefore, in a process of displaying the interaction picture, the terminal first displays a group photo template corresponding to the key information; then transmits a virtual avatar obtaining request to a server; receives a virtual avatar of the first object and a virtual avatar of the second object that are fed back by the server in response to the virtual avatar obtaining request; and displaying the virtual avatar of the first object and the virtual avatar of the second object.

The group photo template may be a background image that matches the key information and is configured for a group photo of virtual objects. For example, the key information is “Happy birthday”, and the group photo template may be a background image having a birthday atmosphere or a birthday element.

In an embodiment, in addition to requesting the virtual avatar of the first object from the server, the terminal may alternatively locally obtain the virtual avatar of the first object. For example, the virtual avatar of the first object may be buffered locally, so that the terminal may directly obtain the virtual avatar of the first object locally when display is needed.

In an embodiment, the first object and the second object are members in a communication group. After the first object transmits the first conversation message and the interaction picture is displayed, the terminal transmits target information to the server. The target information includes identification information of the group photo template, object information of the first object, and object information of the second object. The target information is indicating the server to transmit the identification information and virtual avatars corresponding to the object information to a terminal of an other object in the communication group, so as to display the group photo template and the virtual avatars corresponding to the object information (that is, the virtual avatar of the first object and the virtual avatar of the second object) on the terminal of the other object.

In an embodiment, after interaction is completed, a group photo image or group photo video may be captured and stored. Specifically, the terminal performs image capture or video capture on the interaction picture, to obtain the group photo image or the group photo video. Alternatively, waiting time is recorded, and image capture or video capture is performed on the interaction picture when the waiting time meets a preset time condition, to obtain the group photo image or the group photo video. Alternatively, statics on a quantity of objects in the interaction picture is collected, and image capture or video capture is performed on the interaction picture when the quantity of objects meets a preset quantity condition, to obtain the group photo image or the group photo video.

During image capture or video capture, selection may be performed based on an actual requirement. For example, a selection page is displayed for selecting an image format or a video format to be captured. The selection page may be displayed on a side of the first object, or may be displayed on a side of the second object, or may be displayed on all terminals of objects that transmit messages including the key information.

For video capture, video recording duration and a recording node may be configured, and then a video format file is exported based on a built-in rendering engine (for example, a component of Sequencer of UE4).

For image capture, a captured group photo image may be a dynamic image or a static image. For the dynamic image, a node array including key frames is configured in configuration information, and a group photo image of these key frames may be generated by default. In addition, the user may alternatively take a screenshot, for example, invoke a screenshot function of the rendering engine (a component of Scene Capture of UE4), to obtain the group photo image.

In an embodiment, a video or an image may be captured at a fixed position, or may be captured at a dynamic position. Specifically, the terminal performs image capture or video capture on the interaction picture at a fixed position through a virtual camera, to obtain the group photo image or the group photo video. Alternatively, image capture or video capture is performed on the interaction picture along a target path through the virtual camera, to obtain the group photo image or the group photo video.

The target path may be a preset capture route, or may be manually set by the user (for example, the first object) in a capture process.

During image or video capture, a virtual capture device (for example, a virtual mobile phone or a tablet computer) and a virtual user operating the capture device or a hand of the virtual user may be displayed in a conversation page, and virtual avatars, virtual props, and the like in the interaction picture are displayed in a display screen of the capture device, as shown in FIG. 8.

In an embodiment, after the group photo image or the group photo video is captured, the terminal may save the group photo image or the group photo video in albums of objects in the interaction picture; or save the group photo image or the group photo video in an album of the communication group, the communication group being a group of the objects in the interaction picture, and the conversation page being a group chat page of the communication group.

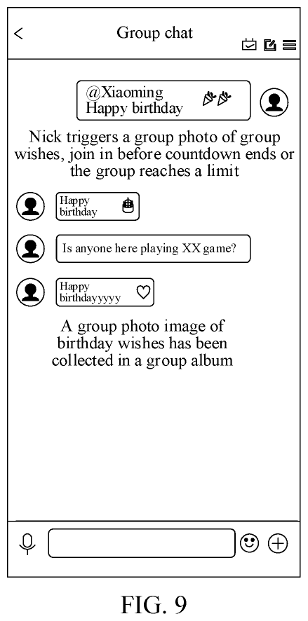

In addition, after the group photo image or group photo video is saved, the terminal may display prompt information indicating that saving is completed, as shown in FIG. 9.

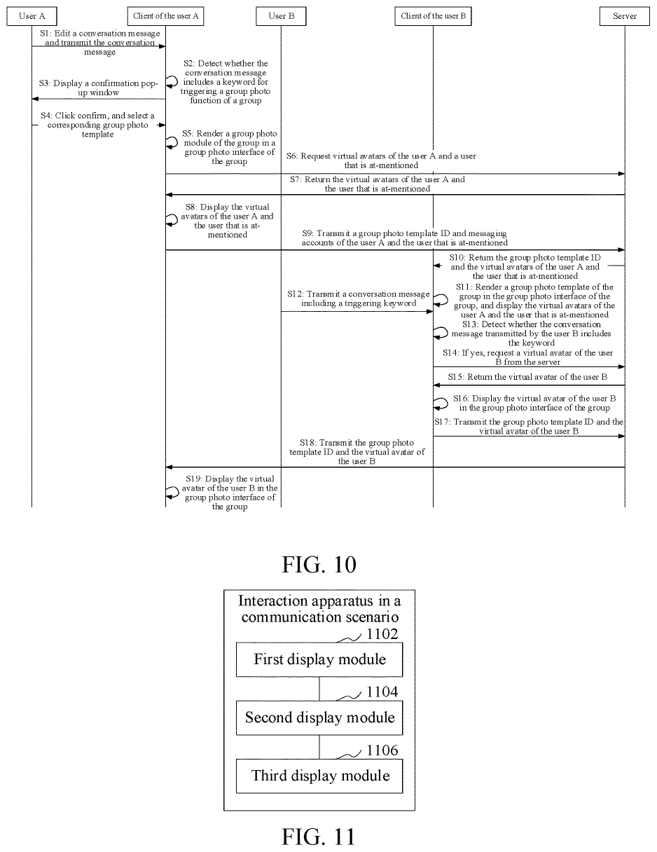

To understand the technical solutions of the present disclosure more clearly, descriptions are provided herein with reference to FIG. 3A, FIG. 5, FIG. 6, FIG. 8, FIG. 9, and FIG. 10. As shown in FIG. 10, the group avatar collage method in the present disclosure is specifically as follows.

S1: A user A edits a conversation message and transmits the conversation message.

S2: A client of the user A detects whether the conversation message includes a keyword for triggering a group avatar collage function.

The client of the user A may refer to an instant messaging application used by the user A.

S3: The client of the user A displays a confirmation pop-up window.

S4: The user A clicks confirm, and selects a corresponding group photo template.

S5: The client of the user A renders a group photo module of the group in a group avatar collage interface.

S6: The client of the user A requests virtual characters of the user A and a user that is at-mentioned, as shown in FIG. 3A.

S7: A server returns the virtual characters of the user A and the user that is at-mentioned.

S8: The client of the user A displays the virtual characters of the user A and the user that is at-mentioned.

S9: The client of the user A transmits a group avatar collage template ID and messaging accounts of the user A and the user that is at-mentioned.

S10: The server returns the group photo template ID and the virtual characters of the user A and the user that is at-mentioned to a client of a user B

S11: The client of the user B renders a group avatar collage template in the group avatar collage interface, and displays the virtual characters of the user A and the user that is at-mentioned.

S12: The user B transmits a conversation message including a triggering keyword.

S13: The client of the user B detects whether the conversation message transmitted by the user B includes the keyword.

S14: If yes, the client of the user B requests a virtual character of the user B from the server.

S15: The server returns the virtual character of the user B to the client of the user B.

S16: The client of the user B displays the virtual character of the user B in the group avatar collage interface.

S17: The client of the user B transmits the group avatar collage template ID and the virtual character of the user B to the server.

S18: The server transmits the group avatar collage template ID and the virtual character of the user B to the client of the user A.

S19: The client of the user A displays the virtual character of the user B in the group avatar collage interface, as shown in FIG. 5 and FIG. 6.

When countdown is 0 or the quantity reaches a specified quantity threshold, group photo video or group photo image capture starts, as shown in FIG. 8. Then the captured group photo video or group photo image is saved in a group album, and then the prompt information is displayed, as shown in FIG. 9.

Although all the operations in the flowcharts of the embodiments are displayed sequentially as indicated by the arrows, the operations are not necessarily executed sequentially as indicated by the arrows. Unless clearly specified in this specification, there is no strict sequence limitation on the execution of the operations, and the operations may be performed in another sequence. In addition, at least some operations in the flowcharts involved in the foregoing embodiments may include a plurality of operations or a plurality of stages, and the operations or stages are not necessarily performed at the same moment, and may be performed at different moments. The operations or stages are not necessarily performed in sequence, and may be performed in turns or alternately with other operations, or at least a part of operations or stages in the other operations.

Based on the same inventive concept, an embodiment of the present disclosure further provides an interaction apparatus in a communication scenario configured to implement the foregoing interaction method in a communication scenario. An implementation solution provided by the apparatus for resolving a problem is similar to the implementation solution recorded in the foregoing method. Therefore, for specific limitations on one or more following embodiments of the interaction apparatus in a communication scenario, reference may be made to the limitations on the foregoing interaction method in a communication scenario. Details are not described herein again.

In an embodiment, as shown in FIG. 11, an interaction apparatus in a communication scenario is provided, including: a first display module 1102, a second display module 1104, and a third display module 1106.

The first display module 1102 is configured to display, in a conversation page of an application, a first conversation message transmitted by a first object.

The second display module 1104 is configured to display an interaction picture corresponding to key information when the first conversation message includes the key information and prompt information that is with respect to a second object, the interaction picture including a virtual avatar of the first object and a virtual avatar of the second object.

The third display module 1106 is configured to display a virtual prop in the interaction picture in response to that the first conversation message includes the virtual prop; or display, in response to that the first conversation message includes a virtual expression, that at least one virtual avatar in the interaction picture presents an expression corresponding to the virtual expression.

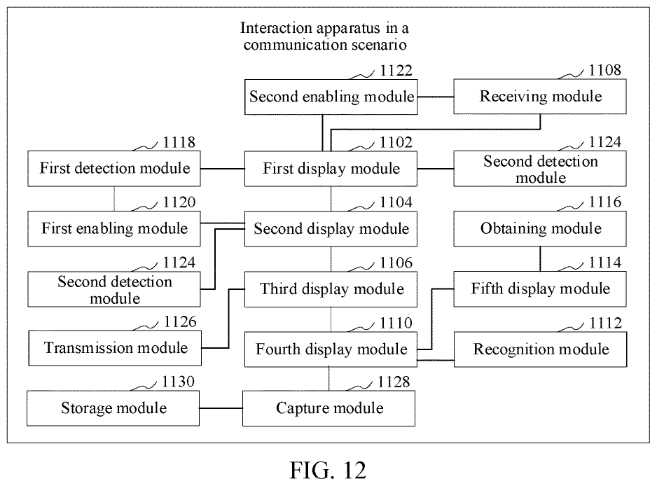

In an embodiment, as shown in FIG. 12, the apparatus further includes:
a receiving module 1108, configured to receive the first conversation message transmitted by the first object; and
the first display module 1102, further configured to display the first conversation message in the conversation page of the application when the first conversation message being a text type message or an image-text type message; and display, when the first conversation message is a conversation message of an audio type or a video type, a media identifier representing the first conversation message in the conversation page.

In an embodiment, as shown in FIG. 12, the apparatus further includes:
a fourth display module 1110, configured to display, on the virtual avatar of the second object, a virtual prop indicating that the second object is a protagonist.

In an embodiment, the first conversation message is the conversation message of the text type or the image-text type; and
the fourth display module 1110 is further configured to obtain, in response to that the first conversation message includes target interaction information, a target virtual prop corresponding to the target interaction information from an expression library, and display the obtained target virtual prop in the interaction picture; or generate a corresponding target virtual prop based on the target interaction information, and display the generated target virtual prop in the interaction picture.

In an embodiment, the first conversation message is the conversation message of the audio type or the video type. As shown in FIG. 12, the apparatus further includes:
a recognition module 1112, configured to performing speech recognition on the first conversation message, to obtain a speech recognition text; and
the fourth display module 1110, configured to obtain, in response to that the speech recognition text includes the target interaction information, the target virtual prop corresponding to the target interaction information from the expression library, and display the target virtual prop in the interaction picture.

In the foregoing embodiments, the first conversation message transmitted by the first object is displayed in the conversation page of the application, and when the first conversation message includes the key information and the prompt information that is with respect to the second object, the interaction picture that is corresponding to the key information and that includes the virtual avatar of the first object and the virtual avatar of the second object is displayed. Therefore, not only is interaction performed in a message level, but also the virtual avatars of the objects participating in the conversation are associated, so that interaction between the virtual avatars of the objects is presented, which facilitates improvement of an interaction effect. In addition, in the case that the first conversation message includes the virtual prop, the virtual prop is displayed in the interaction picture. Alternatively, in the case that the first conversation message includes the virtual expression, that the at least one virtual avatar in the interaction picture presents the expression corresponding to the virtual expression is displayed, so that the virtual avatar presents the expression corresponding to the virtual expression, thereby increasing an interaction atmosphere, facilitating more objects to participate in interaction, and effectively improving an interaction rate.

In an embodiment, the first object and the second object are members in a communication group; and as shown in FIG. 12, the apparatus further includes:
a fifth display module 1114, configured to display, in the conversation page, a second conversation message transmitted by an other object in the communication group; and display a virtual avatar of the other object in the interaction picture when the second conversation message includes the key information or information corresponding to the key information.

In an embodiment, as shown in FIG. 12, the apparatus further includes:
an obtaining module 1116, configured to obtain receiving time of the second conversation message when receiving the second conversation message transmitted by the other object in the communication group; and
the fifth display module 1114, further configured to display the virtual avatar of the other object in the interaction picture when the second conversation message includes the key information or the information corresponding to the key information and the receiving time meets a preset time condition.

In an embodiment, there are at least two other objects; and
the fifth display module 1114 is further configured to display the virtual avatars of the other objects on two sides or around the second object by using a position of the second object as a center.

In an embodiment, as shown in FIG. 12, the apparatus further includes:
a first detection module 1118, configured to detect inputted conversation content in a process in which the first object inputs a conversation message, to obtain a first detection result; and
a first enabling module 1120, configured to enable, when the first detection result includes the key information and the prompt information that is with respect to the second object, a function for displaying a virtual avatar to perform group photo interaction; or display a group photo confirmation page when the first detection result includes the key information and the prompt information that is with respect to the second object, and enable, in response to a confirmation operation triggered in the group photo confirmation page, a function for displaying a virtual avatar to perform group photo interaction.

In an embodiment, as shown in FIG. 12, the apparatus further includes:
the receiving module 1108, configured to receive control speech transmitted by the first object; and
a second enabling module 1122, configured to enable, when the control speech includes a group photo enabling command, the function for displaying a virtual avatar to perform group photo interaction; or enable, in response to a triggered group photo enabling operation, the function for displaying a virtual avatar to perform group photo interaction.

In an embodiment, as shown in FIG. 12, the apparatus further includes:
a second detection module 1124, configured to perform information detection on the first conversation message, to obtain a second detection result; and
the second display module 1104, further configured to display the group photo confirmation page when the second detection result indicates that the first conversation message includes the key information and the prompt information that is with respect to the second object; and display the interaction picture corresponding to the key information in response to the confirmation operation triggered in the group photo confirmation page.

In an embodiment, the interaction picture further includes a group photo template; and
the second display module 1104 is further configured to display a group photo template corresponding to the key information; transmit a virtual avatar obtaining request to a server; receive the virtual avatar of the first object and the virtual avatar of the second object that are fed back by the server in response to the virtual avatar obtaining request; and display the virtual avatar of the first object and the virtual avatar of the second object.

In an embodiment, the first object and the second object are members in the communication group; and as shown in FIG. 12, the apparatus further includes:
a transmission module 1126, configured to transmit target information to the server, the target information including identification information of the group photo template, object information of the first object, and object information of the second object, the target information being indicating the server to transmit the identification information and virtual avatars corresponding to the object information to a terminal of the other object in the communication group, to display the group photo template and the virtual avatars corresponding to the object information on the terminal of the other object.

In an embodiment, as shown in FIG. 12, the apparatus further includes:
a capture module 1128, configured to perform image capture or video capture on the interaction picture, to obtain a group photo image or a group photo video; or record waiting time, and perform image capture or video capture on the interaction picture when the waiting time meets a preset time condition, to obtain a group photo image or a group photo video; or collect statics on a quantity of objects in the interaction picture, and perform image capture or video capture on the interaction picture when the quantity of objects meets a preset quantity condition, to obtain a group photo image or a group photo video.

In an embodiment, the capture module 1128 is further configured to perform image capture or video capture on the interaction picture at a fixed position through a virtual camera, to obtain a group photo image or a group photo video; or perform image capture or video capture on the interaction picture along a target path through a virtual camera, to obtain a group photo image or a group photo video.

In an embodiment, as shown in FIG. 12, the apparatus further includes:
a storage module 1130, configured to save the group photo image or the group photo video in albums of the objects in the interaction picture; or save the group photo image or the group photo video in an album of the communication group, the communication group being a group of the objects in the interaction picture, and the conversation page being a group chat page of the communication group.

All the modules in the interaction apparatus may be partially or completely implemented through software, hardware, or any combination thereof. The foregoing modules may be built in or independent of a processor of a computer device in a form of hardware, or may be stored in a memory of the computer device in a form of software, for the processor to invoke to perform operations corresponding to the foregoing modules.

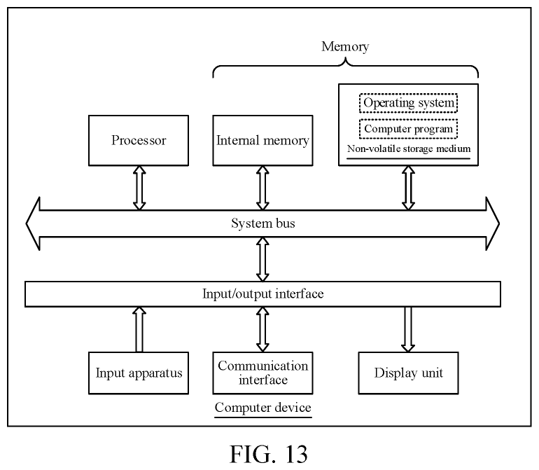

In an embodiment, a computer device is provided. The computer device may be a terminal, and a diagram of an internal structure thereof may be shown in FIG. 13. The computer device includes a processor, a memory, an input/output (I/O) interface, a communication interface, a display unit, and an input apparatus. The processor, the memory, and the input/output interface are connected via a system bus, and the communication interface, the display unit, and the input apparatus are connected to the system bus via the input/output interface. The processor of the computer device is configured to provide computing and control capabilities. The memory of the computer device includes a non-volatile storage medium and an internal memory. The non-volatile storage medium has an operating system and a computer program stored therein. The internal memory provides an operation environment for the operating system and the computer program in the non-volatile storage medium. The input/output interface of the computer device is configured for exchanging information between the processor and an external device. The communication interface of the computer device is configured to communicate with an external terminal in a wired or wireless mode. The wireless mode may be implemented through wireless fidelity (WIFI), a mobile cellular network, near field communication (NFC), or another technology. The computer program, when executed by the processor, implements an interaction method in a communication scenario. The display unit of the computer device is configured to form a visual picture, and may be a display screen, a projection apparatus, or a virtual reality imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, a touchpad, a mouse, or the like.

A person skilled in the art may understand that, the structure shown in FIG. 13 is only a block diagram of a part of a structure related to the application solutions and does not limit the computer device to which the application solutions are applied. Specifically, the computer device may include more or fewer components than those in the drawings, or some components are combined, or a different component arrangement is used.

In an embodiment, a computer device is provided, including a memory and a processor, the memory having a computer program stored therein, and the processor, when executing the computer program, implementing operations of the foregoing interaction method in a communication scenario.

In an embodiment, a computer-readable storage medium is provided, having a computer program stored therein, the computer program, when executed by a processor, implementing operations of the foregoing interaction method in a communication scenario.

In an embodiment, a computer program product is provided, including a computer program, the computer program, when executed by a processor, implementing operations of the foregoing interaction method in a communication scenario.

User information (including, but not limited to, user equipment information, user personal information, and the like) and data (including, but not limited to, data for analysis, stored data, displayed data, and the like) involved in the present disclosure are information and data that are authorized by a user or fully authorized by all parties, and collection, use, and processing of related data need to comply with relevant laws and regulations of relevant countries and regions.

A person of ordinary skill in the art may understand that some or all procedures in the foregoing method embodiments may be implemented by a computer program instructing related hardware. The computer program may be stored in a non-volatile computer-readable storage medium, and when the computer program is executed, the procedures of the foregoing method embodiments may be performed. Any reference to a memory, a database, or another medium used in the various embodiments provided herein may include at least one of a non-volatile and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric m random access memory (FRAM), a phase change memory (PCM), a graphene memory, and the like. The volatile memory may include a random access memory (RAM) or an external cache memory, and the like. For the purpose of description instead of limitation, the RAM is available in a plurality of forms, for example, a static random access memory (SRAM) or a dynamic random access memory (DRAM). The database in the embodiments provided in the present disclosure may include at least one of a relational database and a non-relational database. The non-relational database may include a blockchain-based distributed database and the like, but is not limited thereto. The processor involved in the embodiments provided in the present disclosure may be a general-purpose processor, a central processing unit, a graphics processing unit, a digital signal processor, a programmable logic device, a data processing logic device based on quantum computing, or the like, but is not limited thereto.

Technical features of the foregoing embodiments may be combined in different manners to form other embodiments. For concise description, not all possible combinations of the technical features in the embodiment are described. However, provided that combinations of the technical features do not conflict with each other, the combinations of the technical features are considered as falling within the scope recorded in this specification.

The foregoing embodiments only describe several implementations of the present disclosure specifically and in detail, but cannot be construed as a limitation to the patent scope of the present disclosure. A person of ordinary skill in the art may make various changes and improvements without departing from the ideas of the present disclosure, which shall all fall within the protection scope of the present disclosure. Therefore, the protection scope of the present disclosure is subject to the protection scope of the appended claims.

What is claimed is:

1. A picture display method in a communication scenario, the method comprising:
displaying, in a conversation page of an application, a first conversation message transmitted by a first object;
determining that the first conversation message comprises key information and prompt information that is with respect to a second object;
displaying an interaction picture corresponding to the key information, the interaction picture comprising a virtual avatar of the first object and a virtual avatar of the second object; and
displaying a virtual prop in the interaction picture in response to the first conversation message comprising the virtual prop; or displaying, in response to the first conversation message comprising a virtual expression, that at least one virtual avatar in the interaction picture presents an expression corresponding to the virtual expression.

2. The method according to claim 1, further comprising:
receiving the first conversation message transmitted by the first object; and
the displaying the first conversation message transmitted by the first object comprising:
displaying the first conversation message in the conversation page of the application in response to the first conversation message being a text type message or an image-text type message; and
displaying, in response to the first conversation message being an audio type message or a video type message, a media identifier representing the first conversation message in the conversation page.

3. The method according to claim 1, further comprising:
displaying, on the virtual avatar of the second object, a virtual prop indicating that the second object is a protagonist.

4. The method according to claim 1, wherein the first conversation message is of a text type or an image type; and the method further comprises:
obtaining, in response to the first conversation message comprising target interaction information, a target virtual prop corresponding to the target interaction information from an expression library, and displaying the obtained target virtual prop in the interaction picture; or
generating a corresponding target virtual prop based on the target interaction information, and displaying the generated target virtual prop in the interaction picture.

5. The method according to claim 1, the first object and the second object are members in a communication group; and
the method further comprises:
displaying, in the conversation page, a second conversation message transmitted by an other object in the communication group; and
displaying a virtual avatar of the other object in the interaction picture in response to the second conversation message comprising the key information or information corresponding to the key information.

6. The method according to claim 5, further comprising:
obtaining receiving time of the second conversation message upon receiving the second conversation message transmitted by the other object in the communication group; and
the displaying the virtual avatar of the other object in the interaction picture comprises:
displaying the virtual avatar of the other object in the interaction picture in response to that the second conversation message comprises the key information or the information corresponding to the key information and that the receiving time meets a preset time condition.

7. The method according to claim 6, wherein there are at least two other objects; and the displaying the virtual avatar of the other object in the interaction picture comprises:
displaying the virtual avatars of the other objects on two sides or around the second object by using a position of the second object as a center.

8. The method according to claim 1, wherein the first conversation message is of an audio type or a video type; the method further comprises:
performing speech recognition on the first conversation message, to obtain a speech recognition text; and
the method further comprises: obtaining, in response to the speech recognition text comprising the target interaction information, the target virtual prop corresponding to the target interaction information from the expression library, and displaying the target virtual prop in the interaction picture.

9. The method according to claim 1, wherein the method is applied to a terminal coupled to the first object, and the method further comprises:
detecting inputted conversation content in a process in which the first object inputs a conversation message, to obtain a first detection result;
in response to that the first detection result comprises the key information and the prompt information that is with respect to the second object:
displaying a function for group photo interaction based on virtual avatar; or displaying a group photo confirmation page; and activating, in response to a confirmation operation triggered in the group photo confirmation page, the function for group photo interaction.

10. The method according to claim 1, wherein the method is applied to the terminal coupled to the first object; and
the method further comprises:
receiving control speech transmitted by the first object, and activating, in response to the control speech comprising a group photo enabling command, a function for group photo interaction based on virtual avatar; or
activating, in response to a triggered group photo enabling operation, the function for group photo interaction.

11. The method according to claim 1, wherein the method is applied to the terminal held by the first object; the method further comprises:
performing information detection on the first conversation message, to obtain a second detection result; and
the displaying the interaction picture corresponding to key information comprises:
displaying the group photo confirmation page in response to the second detection result indicating that the first conversation message comprises the key information and the prompt information that is with respect to the second object; and
displaying the interaction picture corresponding to the key information in response to the confirmation operation triggered in the group photo confirmation page.

12. The method according to claim 11, wherein the interaction picture further comprises a group photo template; and the displaying the interaction picture corresponding to key information comprises:
displaying a group photo template corresponding to the key information;
transmitting a virtual avatar obtaining request to a server;
receiving the virtual avatar of the first object and the virtual avatar of the second object that are fed back by the server in response to the virtual avatar obtaining request; and
displaying the virtual avatar of the first object and the virtual avatar of the second object.

13. The method according to claim 12, wherein the first object and the second object are members in the communication group; and the method further comprises:
transmitting target information to the server, the target information comprising identification information of the group photo template, object information of the first object, and object information of the second object,
the target information being configured to instruct the server to transmit the identification information and virtual avatars corresponding to the object information to a terminal of the other object in the communication group, to display the group photo template and the virtual avatars corresponding to the object information on the terminal of the other object.

14. The method according to claim 1, further comprising:
performing image capture or video capture on the interaction picture, to obtain a group photo image or a group photo video.

15. The method according to claim 14, wherein the image capture or the video capture is performed in response to at least one of:
a waiting time for the interaction picture meeting a preset time condition; or
a quantity of objects in the interaction picture meeting a preset quantity condition.

16. The method according to claim 14, wherein the performing image capture or video capture on the interaction picture, to obtain the group photo image or the group photo video comprises:
performing image capture or video capture on the interaction picture at a fixed position through a virtual camera, to obtain the group photo image or the group photo video; or
performing image capture or video capture on the interaction picture along a target path through the virtual camera, to obtain the group photo image or the group photo video.

17. The method according to claim 14, further comprising:
saving the group photo image or the group photo video in albums of the objects in the interaction picture; or
saving the group photo image or the group photo video in an album of the communication group, the communication group being a group of the objects in the interaction picture, and the conversation page being a group chat page of the communication group.

18. A computer device, comprising a memory and a processor, the memory having a computer program stored therein, and the processor, when executing the computer program, being configured to implement:
displaying, in a conversation page of an application, a first conversation message transmitted by a first object;
determining that the first conversation message comprises key information and prompt information that is with respect to a second object;
displaying an interaction picture corresponding to the key information, the interaction picture comprising a virtual avatar of the first object and a virtual avatar of the second object; and
displaying a virtual prop in the interaction picture in response to the first conversation message comprising the virtual prop; or displaying, in response to the first conversation message comprising a virtual expression, that at least one virtual avatar in the interaction picture presents an expression corresponding to the virtual expression.

19. The computer device according to claim 18, the first object and the second object are members in a communication group; and
the processor is further configured to implement:
displaying, in the conversation page, a second conversation message transmitted by an other object in the communication group; and
displaying a virtual avatar of the other object in the interaction picture in response to the second conversation message comprising the key information or information corresponding to the key information.

20. A non-transitory computer-readable storage medium, having a computer program stored therein, the computer program, when executed by a processor, causing the processor to implement:
displaying, in a conversation page of an application, a first conversation message transmitted by a first object;
determining that the first conversation message comprises key information and prompt information that is with respect to a second object;
displaying an interaction picture corresponding to the key information, the interaction picture comprising a virtual avatar of the first object and a virtual avatar of the second object; and
displaying a virtual prop in the interaction picture in response to the first conversation message comprising the virtual prop; or displaying, in response to the first conversation message comprising a virtual expression, that at least one virtual avatar in the interaction picture presents an expression corresponding to the virtual expression.
